(19) United States
(12) Patent Application Publication
(10) Pub. No.: US 2018/0099780 A1
(43) Pub. Date: Apr. 12, 2018

(54) Stackable Sawblade Containment Assembly

(71) Applicant: John Lee, Riverside, CA (US)

(72) Inventor: John Lee, Riverside, CA (US)

(21) Appl. No.: 15/289,025

(22) Filed: Oct. 7, 2016

(51) Int. Cl. B65D 21/02; B65D 25/54; B65D 25/20; B65D 25/22; B23D 59/00; B23Q 13/00

(52) U.S. Cl. CPC B65D 21/0209; B65D 25/54; B23Q 13/00; B65D 25/22; B23D 59/00; B65D 25/205

(57) ABSTRACT

A stackable sawblade containment assembly contains saw blades in a stacked arrangement with stackable annular covers. The saw blades are securely contained in cavities formed through stacked arrangement of the covers. The annular covers have a containment face with a protrusion, and a base face with a depression. The protrusion and the depression are detachably connected in a snap-fit relationship forming an inner cavity and a stacked arrangement of annular covers. A lip extends along the length of the outer perimeter of the covers. A tab extends from the containment face. The lip and the tab inhibit lateral slippage of the saw blade. A flange extends from the outer perimeter of the annular covers to retain a sensor tag in a flange depression. A flange cover covers the sensor tag. A flat extension extends from the outer perimeter, opposite the flange, to enable upright standing of the covers.

### FIELD OF THE INVENTION

The present invention relates generally to a stackable sawblade containment assembly. More so, the present invention relates to a containment assembly that is configured to contain at least one saw blade within cavities formed through stacked arrangement of a plurality of stackable annular covers; whereby the annular covers have a containment face with a protrusion, and a base face with a depression; whereby the protrusion of the containment face, and the depression of the base face are detachably connected in a snap-fit relationship forming an inner cavity and a stacked arrangement of annular covers; whereby an inner and outer lip on the corresponding perimeters of the covers, along with at least one tab extending from the containment face work to inhibit lateral slippage of the saw blade; whereby a flange extends from the outer perimeter of the annular covers to retain a sensor tag; and whereby a flat extension extends from an opposite end of the outer perimeter to enable upright standing of the annular covers.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Generally, a saw is a tool consisting of a tough blade, wire, or chain with a hard toothed edge. It is used to cut through material, most often wood. The cut is made by placing the toothed edge against the material and moving it forcefully forth and less forcefully back or continuously forward. A circular blade saw is a circular blade which spins, usually by a power tool. Circular saws can be large for use in a mill or hand held up to 24″ blades and different designs cut almost any kind of material including wood, stone, brick, plastic, etc.

Generally, circular saw blades with angled teeth are used extensively for cutting any material mainly because of their rapid and accurate cutting action and ability to cut for a reasonable period of duration without sharpening. A circular saw blade contains a hole in the center and is of a planar design with peripheral teeth. Circular saw blades come in various diameters as well as various saw blade thicknesses since they are designed for cutting specific material such as wood, metal or masonry.

It is known that the angled teeth of circular saw blades are precision cutting tools, the user must apply care when storing and handling saw blades in order to safeguard against both moisture, which rusts metal blades and negatively affects the blades cutting performance, or contact with other blades and tools, which may lead to dulled cutting teeth.

Other proposals have involved storing circular saw blades. The problem with these storage devices is that they do not enable stacked, efficient storage capacity of the saw blades. Also, the blades slide loosely inside the container causing damage to the teeth. Even though the above cited blade storage devices meets some of the needs of the market, a containment assembly that contains at least one saw blade within cavities formed through stacked arrangement of a plurality of stackable annular covers, and an inner and outer lip on the perimeters of the annular covers and at least one tab to inhibit lateral slippage of the saw blade is still desired.

### SUMMARY

Illustrative embodiments of the disclosure are generally directed to a stackable sawblade containment assembly. The stackable sawblade containment assembly is adapted to securely contain at least one saw blade within cavities that from through the stacked arrangement of a plurality of annular covers. Each annular cover is identical and uses opposite faces that mate together in a snap fit relationship to form the cavities that contain the saw blades. The covers can be stacked to any number, so as to retain a large number of saw blades in a stacked arrangement. Also, multiple saw blades can be contained in each formed cavity. The saw blades are also inhibited from lateral sliding through inner and outer lips on the perimeters of the covers, and at least one tab on the face of the covers.

In some embodiments, the annular covers have a containment face with at least one protrusion, and a base face with at least one depression. The protrusion of the containment face, and the depression of the base face are detachably connected in a snap-fit relationship forming an inner cavity to contain at least one saw blade. Any number of covers can be connected in this manner to form a stacked arrangement of annular covers, with each pair forming an inner cavity for containment of the at least one saw blade.

In some embodiments, an outer lip extends along the length of the outer perimeter of the annular covers; and an inner lip extend along the length of the inner perimeter. The lips protrude from the containment face. Thus, the saw blade can rest on the containment face and not slide laterally, as the lips serve as peripheral barriers to inhibit lateral sliding across the containment face. At least one tab extends from the containment face. The tab also works to inhibit lateral slippage of the saw blade.

In some embodiments, a flange extends from the outer perimeter of the annular covers. A flange depression forms in the flange to securely retain a sensor tag. A flange cover is used to securely cover the sensor tag. A flange cover covers the sensor tag, forming a snap-fit relationship with the edges of the flange depression. A flat extension protrudes from the outer perimeter of the covers, diametrically opposed to the flange. The flat extension enables upright standing of the plurality of annular covers.

In one aspect, a stackable sawblade containment assembly, comprises:
a plurality of annular covers defined by a containment face having at least one protrusion, a base face having at least one depression, an inner perimeter, and an outer perimeter;
an outer lip disposed to extend along the length of the outer perimeter and extending from the containment face;
an inner lip disposed to extend along the length of the inner perimeter and extending from the containment face;
whereby the at least one protrusion is disposed in general alignment with the at least one depression,
whereby the at least one protrusion is configured to form a snap-fit relationship with the at least one depression,
whereby the containment face from at least one of the plurality of annular covers, and the base face from at least another one of the plurality of annular covers are detachably connected forming an inner cavity and a stacked arrangement of annular covers;
a flange disposed to extend from the outer perimeter of the plurality of annular covers, the flange comprising a flange depression defined by a depressed edge;
a flange cover defined by a ridged edge, the flange cover configured to cover the flange depression,
whereby the ridged edge of the flange cover forms a snap-fit relationship with the depressed edge of the flange depression;
a flat extension disposed to extend from the outer perimeter of the plurality of annular covers, and diametrically opposed from the flange, the flat extension configured to enable upright standing of the plurality of annular covers; and
at least one tab configured to extend from the containment face, and adjacent to the flat extension.

In another aspect, the plurality of annular covers are at least partially transparent.

In another aspect, the plurality of annular covers are fabricated from a polymer.

In another aspect, the inner cavity is adapted to enable containment of at least one saw blade.

In another aspect, the lip and the at least one tab are configured to inhibit lateral shifting by the at least one saw blade.

In another aspect, the plurality of annular covers are configured to be stacked, and with each set of annular covers containing the at least one saw blade.

In another aspect, the flange depression has a generally rectangular shape.

In another aspect, the flange depression is configured to enable retention of a sensor tag.

In another aspect, the plurality of annular covers have a diameter between the outer perimeters between 22-30 inches.

One objective of the present invention is to store saw blades after purchase in a safe, efficient manner.

Another objective is to inhibit lateral slippage of the saw blades.

Yet another objective is to stack multiple pairs of annular covers, so as to contain five or more saw blades.

Yet another objective is to provide transparent covers that enable quick identification of the saw blade.

Yet another objective is to provide a secure retention of a sensor tag directly on the covers.

Yet another objective is to provide a flat extension to allow merchandisers to display (stand or peg) the product.

Yet another objective is to provide an inexpensive to manufacture saw blade cover.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary stackable sawblade containment assembly, in accordance with an embodiment of the present invention;

FIG. 2 illustrates a top view of an annular cover, facing a containment face and without a flange depression, in accordance with an embodiment of the present invention;

FIG. 3 illustrates a top view of an annular cover, facing a base face and without a flange depression, in accordance with an embodiment of the present invention;

FIG. 4 illustrates a left side view of an annular cover with the containment face oriented down, in accordance with an embodiment of the present invention;

FIG. 5 illustrates a right side view of an annular cover with the containment face oriented down, in accordance with an embodiment of the present invention;

FIG. 6 illustrates a frontal view of an annular cover with the containment face oriented down, in accordance with an embodiment of the present invention;

FIG. 7 illustrates a rear view of an annular cover with the containment face oriented down, in accordance with an embodiment of the present invention;

FIG. 8 illustrates a top view of an annular cover, facing a containment face showing a flange depression in the flange, in accordance with an embodiment of the present invention;

FIG. 9 illustrates a top view of an annular cover, facing a base face showing a flange depression in the flange, in accordance with an embodiment of the present invention;

FIG. 10 illustrates a left side view of a stackable sawblade containment assembly with the containment face oriented up, in accordance with an embodiment of the present invention;

FIG. 11 illustrates a right side view of an annular cover with the containment face oriented up, in accordance with an embodiment of the present invention;

FIG. 12 illustrates a frontal view of an annular cover with the containment face oriented up, in accordance with an embodiment of the present invention;

FIG. 13 illustrates a rear view of an annular cover with the containment face oriented up, in accordance with an embodiment of the present invention;

FIG. 14 illustrates a rear view of an annular cover with no protrusions and the containment face oriented up, in accordance with an embodiment of the present invention; and

FIG. 15 illustrates a perspective view of three annular covers moving to a stacked arrangement, in accordance with an embodiment of the present invention.

Like reference numerals refer to like parts throughout the various views of the drawings.

### DETAILED DESCRIPTION OF THE INVENTION

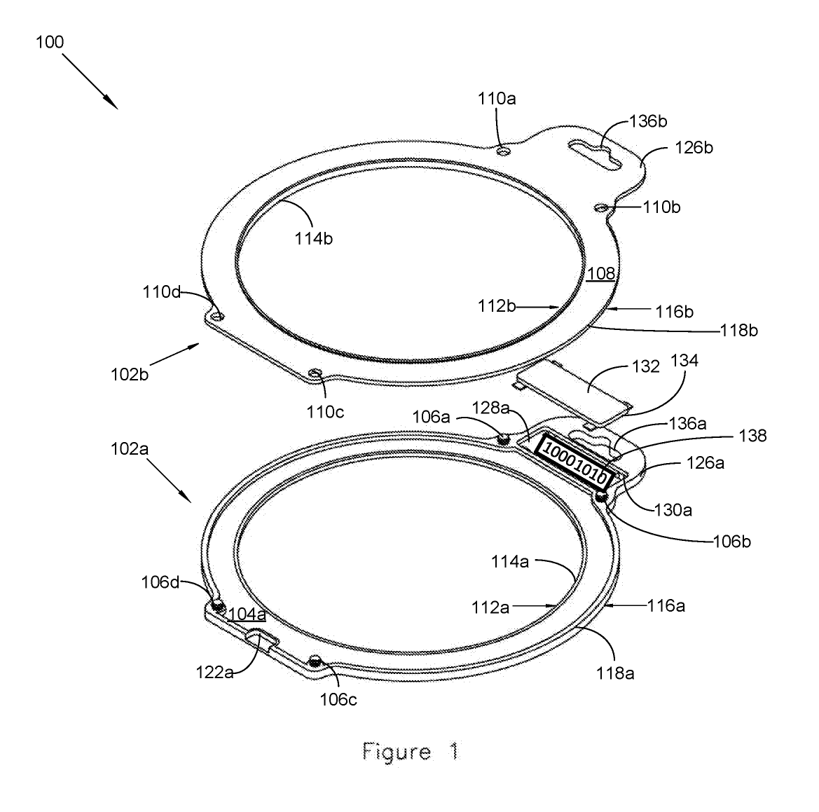

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A stackable sawblade containment assembly 100 is referenced in FIGS. 1-15. The stackable sawblade containment assembly 100, hereafter “assembly 100” is adapted to securely contain at least one saw blade within inner cavities 120a, 120b that from through the stacked arrangement of a plurality of annular covers 102a, 102b, 102c. Each annular cover 102a, 102b, 102c is identical and uses opposite faces 104a, 108 that mate together in a snap fit relationship to form the inner cavities 120a, 120b that contain the saw blades. In essence, providing an efficient, secure solution for single and multi-carbide blade merchandise display, packaging, storage, and quick identification for access to the blades.

As referenced in FIG. 1, the assembly 100 comprises a plurality of annular covers 102a-c. The covers 102a-c have a generally ring-shape that is sized and dimensioned to contain at least one saw blade. The covers 102a-c may also be transparent to enable quick identification and viewing of the at least one saw blade. Though in some embodiments, the annular covers 102a-c may have various colors, patterns, and logos integrated therein. Suitable materials for the annular covers 102a-c may include, without limitation, polyurethane, polyethylene, polyvinyl chloride, silicone, and a rigid polymer.

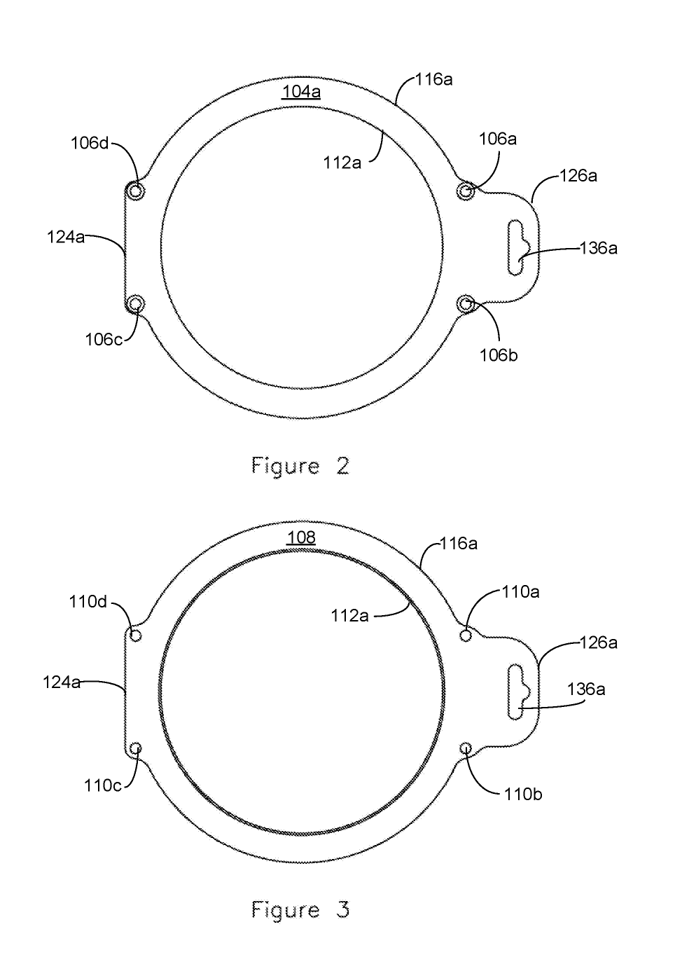

Turning now to FIG. 2, the annular covers 102a-c are defined by a containment face 104a, 104b having at least one protrusion 106a-h and a base face 108 having at least one depression 110a-d. The faces 104a-b, 108 are generally flat, so as to provide a stable surface for the saw blade and minimize warping effects. The containment face 104a is the side of the cover that receives the saw blade. And as FIG. 3 illustrates, the base face 108 is the side of the cover that covers 102a-c an adjacent saw blade in an adjacent containment face 104b.

The generally annular, or ring, shape of the covers 102a-c forms an inner perimeter 112a, 112b, 112c, and an outer perimeter 116a, 116b, 116c with an opening formed inside the inner perimeter 112a, 112b, 112c. This annular shape is designed to follow the general shape of a typical saw blade known in the art. In some embodiments, the cover 102a measured across opposite ends of the outer perimeter 116a, 116b, 116c may have a diameter between 22″-30″.This is substantially the diameter of typical saw blades known in the art.

In one embodiment, an outer lip 118a, 118b, 118c extends along the length of the outer perimeter 116a, 11b, 116c; and an inner lip 114a, 114b, 114c extends along the length of the inner perimeter 112a, 112b, 112c. The lips 112a-c, 114a-c protrude from the containment face 104a, 104b. Thus, the saw blade can rest on the containment face 104a, 104b and be inhibited from lateral sliding, as the lips 112a-c, 114a-c serve as peripheral barriers to inhibit lateral movement across the containment face 104a, 104b.

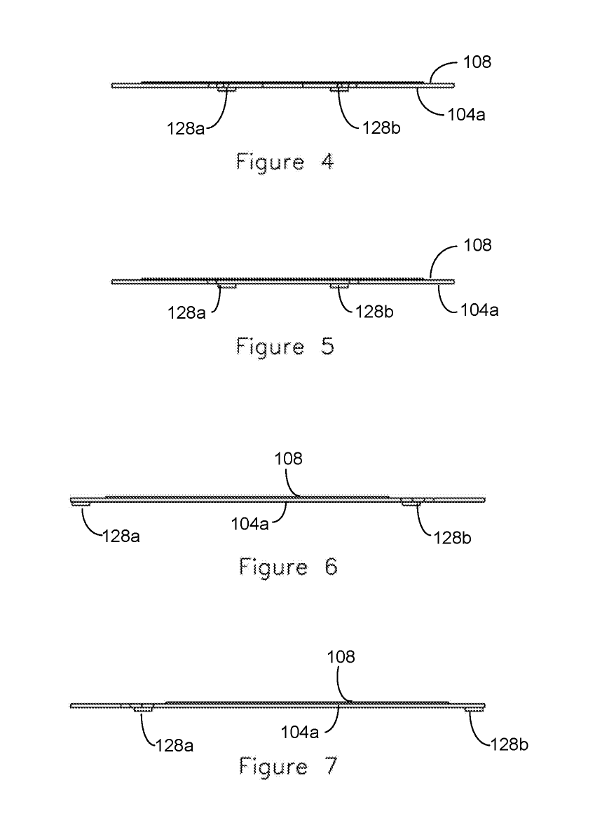

As referenced in FIGS. 4 and 5, the at least one protrusion 106a-h of the containment face 104a, 104bis four protrusions 106a-d, with a pair of spaced-apart protrusions 106a-d at opposite ends of the containment face 104a, 104b. The at least one depression 110a-d of the base face 108 may include four depressions 110a-d, with a pair of spaced-apart depressions 110a-d at opposite ends of the base face 108.

Turning now to FIG. 6, the four protrusions 106a-d are in general alignment with the four depressions 110a-d; whereby each protrusion 106a-d is configured to form a snap-fit relationship with the corresponding depression 110a-d. This creates closure and forms an inner cavity 120a, 120b between the faces 104a, 108 in which at least one blade saw is contained. The inner and outer lips 114a-c, 118a-c further serve to form an inner and outer perimeter 116a, 116b, 116c seal for this closed position (FIG. 7).

In this manner, the containment face 104a from at least one of the annular cover 102a, and the base face 108 from at least another one of the annular covers 102b detachably connect, forming an inner cavity 120a and a stacked arrangement of annular covers 102a, 102b. Additional covers 102c can be stacked, with a subsequent base face engaging a subsequent containment face to form as many inner cavities as needed.

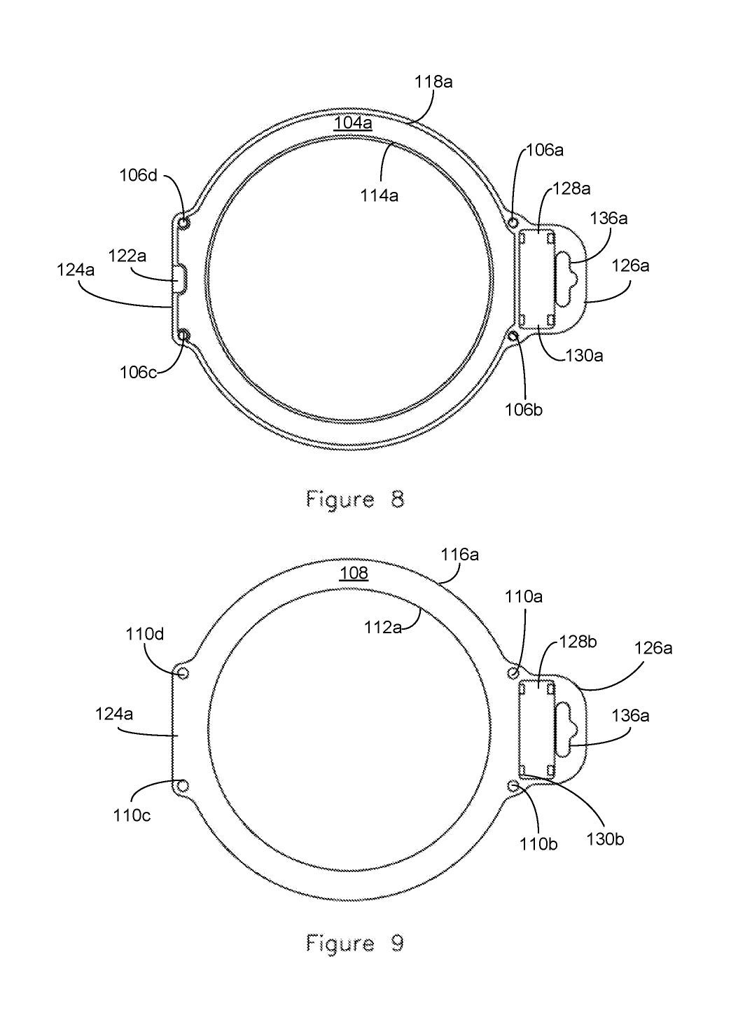

Turning now to FIG. 8, a flange 126a, 126b, 126c extends from the outer perimeter 116a, 116b, 116c of the annular covers 102a-c. The flange 126a, 126b, 126c may have a generally rectangular shape. An elongated slot 136a, 136b, 136c forms at one end of the flange 126a, 126b, 126c. The elongated slot 136a, 136b, 136c may be used for hanging the cover 102a, as for merchandising, packaging, and storage. The elongated slot 136a-c is also effective for aligning multiple covers 102a-c.

Further as FIG. 8 shows, the flange 126a-c is defined by a flange depression 128a, 128b that positions generally central in the flange 126a-c. A depressed edge 130a, 130b forms the perimeter of the flange depression 128a, 128b. The flange depression 128a, 128b is configured to securely retain a sensor tag 138.

Those skilled in the art will recognize that a senor tag 138 is used to digitally track merchandise, which provides an integrated security feature in the assembly 100. The sensor tag 138 may be used to identify and track the covers 102a-c or the saw blades contained within each cover. However, in other embodiments, the flange depression 128a, 128b may retain a simple label that identifies the cover tor the saw blades contained within.

A flange cover 132 securely affixes over the flange depression 128a, 128b. The flange cover 132 may be transparent to enable visibility of the sensor tag 138 contained within the flange depression 128a, 128b. The flange cover 132 is shaped and sized substantially the same as the flange depression 128a, 128b to create a snug mating relationship.

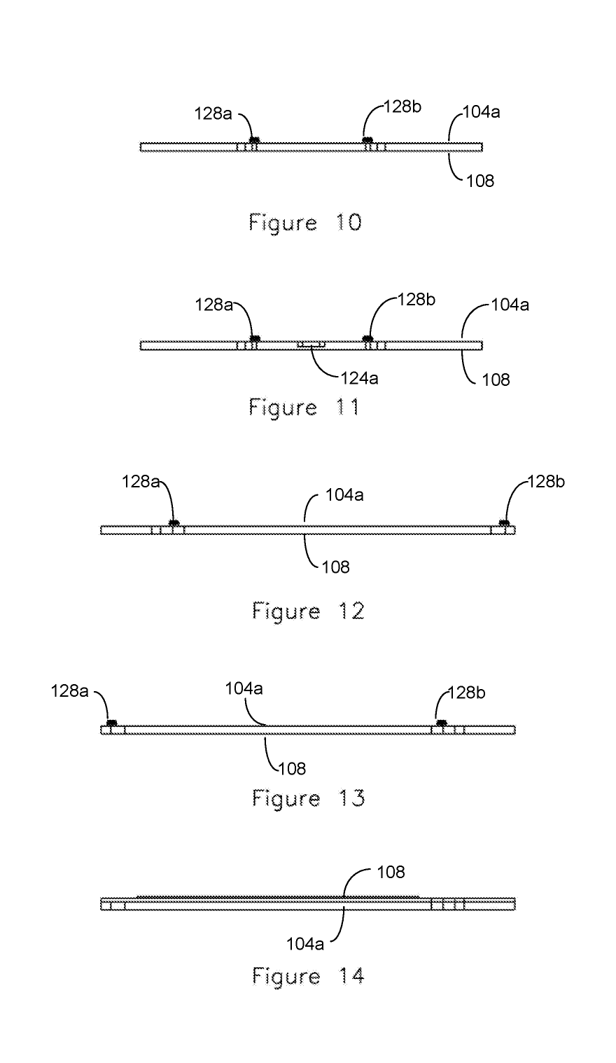

Further, the flange cover 132 has a ridged edge 134 that engages the depressed edge 130a, 130b of the flange depression 128a, 128b. This forms a snap-fit relationship between the flange cover 132 and the flange depression 128a, 128b. However in other embodiments, a plurality of flange tabs may extend from the ridged edge 134 of the flange cover 132 to engage the depressed edge 130a, 130b of the flange depression 128a, 128b in a snap-fit relationship (FIGS. 9 and 10).

As shown in FIG. 11, a flat extension 124a, 124b, 124c extends from the outer perimeter 116a-c of the annular covers 102a-c. The flat extension 124a-c is diametrically opposed from the flange 126a-c. The flat extension 124a-c may have a wide base that enables upright standing of the annular covers 102a-c (FIG. 12). The flat extension 124a-c can also serve as a spacer during packaging and shipping of covers 102a-c.

As discussed above, the inner and outer lips 114a-c, 118a-c form a peripheral barrier that inhibits lateral slippage of the saw blades while in the inner cavity 120a, 120b. The covers 102a-c also utilize at least one tab 122a, 122b that extend from the containment face 104a, 104b, and adjacent to the flat extension 124a-c. The tab 122a, 122b provides a secondary barrier that inhibits lateral movement by the at least one saw blade.

The covers 102a-c can be stacked to any number, so as to retain a large number of saw blades in a stacked arrangement. Also, multiple saw blades can be contained in each formed cavity 120a, 120b. The saw blades are also inhibited from lateral sliding through various barriers that are integrated into the face of the cover.

As discussed above, the annular covers 102a-c have a containment face 104a, 104b with a protrusion 106a-h, and a base face 108 with a depression 110a-d (FIGS. 13 and 14). The protrusion 106a-h of the containment face 104a, 104b, and the depression 110a-d of the base face 108 are detachably connected in a snap-fit relationship forming an inner cavity 120a, 120b to contain at least one saw blade. Any number of covers 102a-c can be connected in this manner to form a stacked arrangement of annular covers 102a-c, with each pair forming an inner cavity 120a, 120b for containment of the at least one saw blade.

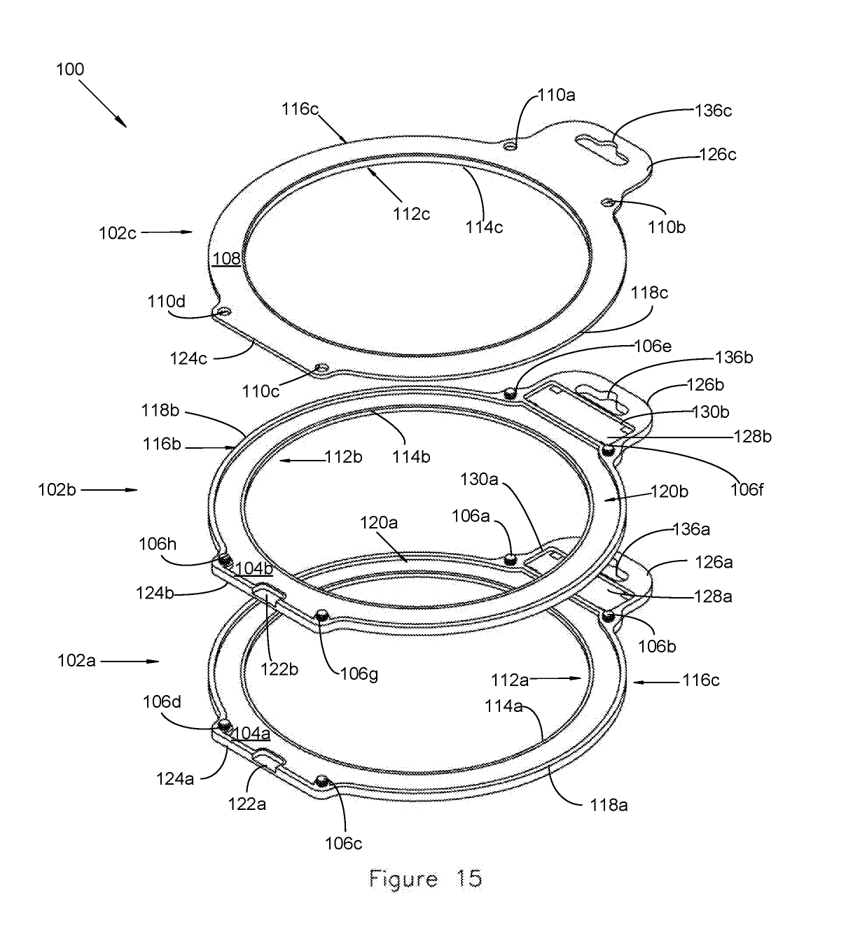

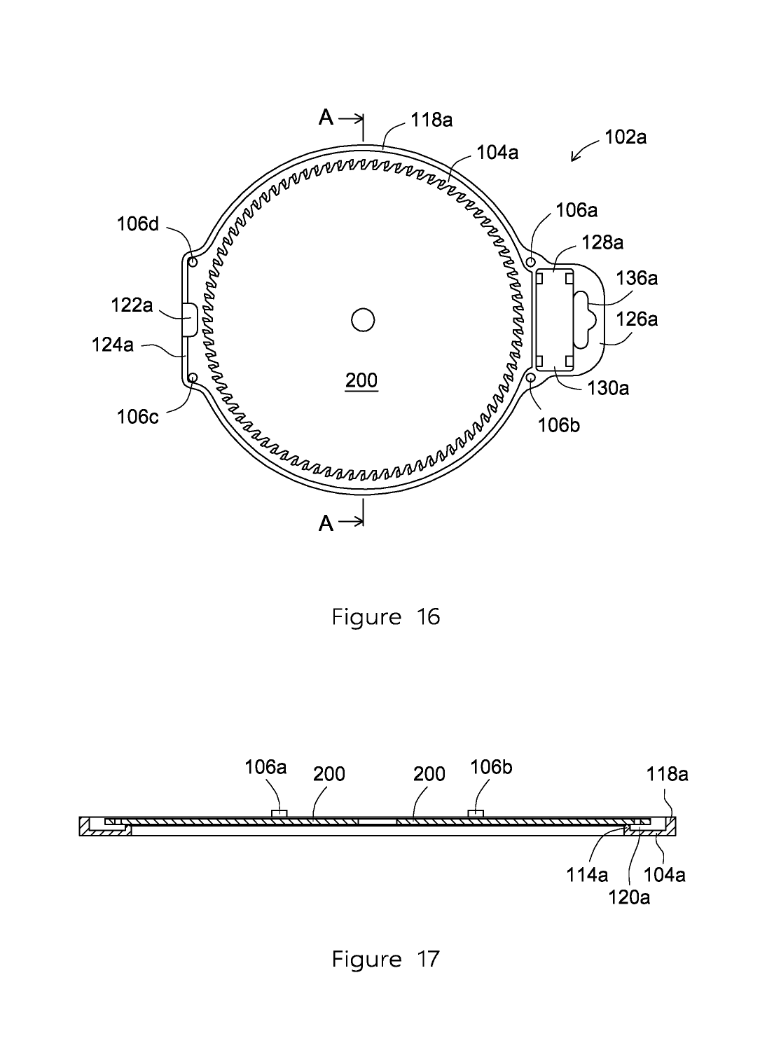

In operation, as FIG. 15 illustrates, at least one saw blade is initially positioned coplanar to the containment face 104a of a first annular cover 102a. The saw blade is placed within the confines of the inner and outer lips 114a, 118a. The tab 122a engages the teeth of the saw blade to inhibit lateral sliding. A base face of a second annular cover is aligned with the first annular cover 102a. The depressions 110a-d on the base face 108 are aligned with the protrusions 106a-d on the containment face 104a, and the corresponding flange 126a and flat extension 124a are also aligned. The two faces 104a are moved together until a snap-fit closure occurs. The saw blade is then secured inside a first pair of annular covers 102a, 102b.

Continuing the stacking arrangement, a third annular cover 102c is used to stack on the second annular cover 102b. The base face 108 of the third annular cover 102c is aligned with the containment face 104b of the second annular cover 102b. The corresponding protrusions 106e-h, depressions 110a-d, flanges 126b, 126c, and flat extensions 124b, 124cs are also aligned. The second and third covers 102, 102c are moved together until a snap-fit closure occurs. The containment face of the third annular cover 102c is then ready to receive a second saw blade. A fourth annular cover and subsequent covers may continue stacking and containing saw blades in this manner.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

1. A stackable sawblade containment assembly, the assembly comprising:
a plurality of annular covers defined by a containment face having at least one protrusion, a base face having at least one depression, and an outer perimeter;
an outer lip disposed to extend along the length of the outer perimeter and extending from the containment face:
whereby the at least one protrusion is disposed in general alignment with the at least one depression,
whereby the at least one protrusion is configured to form a snap-fit relationship with the at least one depression,
whereby the containment face from at least one of the plurality of annular covers, and the base face from at least another one of the plurality of annular covers are detachably connected forming an inner cavity and a stacked arrangement of annular covers;
a flange disposed to extend from the outer perimeter of the plurality of annular covers, the flange comprising a flange depression defined by a depressed edge;
a flange cover defined by a ridged edge, the flange cover configured to cover the flange depression,
whereby the ridged edge of the flange cover forms a snap-fit relationship with the depressed edge of the flange depression;
a flat extension disposed to extend from the outer perimeter of the plurality of annular covers, and diametrically opposed from the flange, the flat extension configured to enable upright standing of the plurality of annular covers; and
at least one recess located on the flat extension.

2. The assembly of claim 1, wherein the plurality of annular covers are at least partially transparent.

3. The assembly of claim 1, wherein the plurality of annular covers are fabricated from a polymer.

4. The assembly of claim 1, wherein the inner cavity is defined by the outer lip and is adapted to enable containment of at least one saw blade.

5. The assembly of claim 4, wherein the outer lip, is configured to inhibit lateral shifting by the at least one saw blade.

6. The assembly of claim 5, wherein the plurality of annular covers are configured to be stacked, and with each set of annular covers containing the at least one saw blade.

7. The assembly of claim 6, wherein the flange depression has a generally rectangular shape.

8. The assembly of claim 7, wherein the flange depression is configured to enable retention of a sensor tag.

9. The assembly of claim 8, wherein the sensor tag is configured to identify the plurality of annular covers and the at least one saw blade, the sensor tag further configured to position in the flange depression.

10. The assembly of claim 1, wherein the plurality of annular covers have a diameter between the outer perimeters between 22 to 30 inches.

11. The assembly of claim 1, wherein the flange further comprises an elongated slot.

12. A stackable sawblade containment assembly, the assembly comprising:
a plurality of annular covers defined by a containment face having at least one protrusion, a base face having at least one depression, and an outer perimeter;
an outer lip disposed to extend along the length of the outer perimeter and extending from the containment face;
whereby the at least one protrusion is disposed in general alignment with the at least one depression,
whereby the at least one protrusion is configured to form a snap-fit relationship with the at least one depression,
whereby the containment face from at least one of the plurality of annular covers, and the base face from at least another one of the plurality of annular covers are detachably connected forming an inner cavity and a stacked arrangement of annular covers;
a flange disposed to extend from the outer perimeter of the plurality of annular covers, the flange comprising a flange depression defined by a depressed edge, the flange further comprising an elongated slot;
a sensor tag configured to identify the plurality of annular covers, the sensor tag. further configured to position in the flange depression;
a flange cover defined by a ridged edge, the flange cover configured to cover the sensor tag in the flange depression, whereby the ridged edge of the flange cover forms a snap-fit relationship with the depressed edge of the flange depression;
a flat extension disposed to extend from the outer perimeter of the plurality of annular covers, and diametrically opposed from the flange, the flat extension configured to enable upright standing of the plurality of annular covers; and
at least one recess located on tab configured to extend from the containment face, and adjacent to the flat extension

13. The assembly of claim 12, wherein the plurality of annular covers are at least partially transparent.

14. The assembly of claim 12, wherein the plurality of annular covers are fabricated from a polymer.

15. The assembly of claim 12, wherein the inner cavity is defined by the outer lip and is adapted to enable containment of at least one saw blade.

16. The assembly of claim 15, wherein the outer lip is configured to inhibit lateral shifting by the at least one saw blade.

17. The assembly of claim 16, wherein the plurality of annular covers are configured to be stacked, and with each set of annular covers containing the at least one saw blade.

18. The assembly of claim 12, wherein the flange depression has a generally rectangular shape.

19. The assembly of claim 12, wherein the plurality of annular covers have a diameter between the outer perimeters between 22 to 30 inches.

20. A stackable sawblade containment assembly, the assembly comprising:
at least one saw blade;
a plurality of annular covers defined by a containment face having at least one protrusion, a base face having at least one depression, and an outer perimeter;
an outer lip disposed to extend along the length of the outer perimeter and extending from the containment face;
whereby the at least one protrusion is disposed in general alignment with the at least one depression,
whereby the at least one protrusion is configured to form a snap-fit relationship with the at least one depression,
whereby the, containment face from at least one of the plurality of annular covers, and the base face from at least another one of the plurality of annular covers are detachably connected forming an inner cavity and a stacked arrangement of annular covers, the inner cavity is defined by the outer lip and is adapted to enable containment of the at least one saw blade;
a flange disposed to extend from the outer perimeter of the plurality of annular covers, the flange comprising a flange depression defined by a depressed edge, the flange further comprising an elongated slot;
a sensor tag configured to identify the plurality of annular covers, the sensor tag further configured to position in the flange depression;
a flange cover defined by a ridged edge, the flange cover configured to cover the sensor tag in the flange depression,
whereby the ridged edge of the flange cover forms a snap-fit relationship with the depressed edge of the flange depression;
a flat extension disposed to extend from the outer perimeter of the plurality of annular covers, and diametrically opposed from the flange, the flat extension configured to enable upright standing of the plurality of annular covers; and
at least one recess located on the flat extension,
wherein the outer lip is configured to inhibit lateral shifting by the at least one saw blade.
